(19) United States
(12) Patent Application Publication
(10) Pub. No.: US 2018/0106419 A1
(43) Pub. Date: Apr. 19, 2018

(54) REUSABLE SAFETY FITTING AND METHOD OF USING THE SAME

(71) Applicant: Robert Kegley, Malibu, CA (US)

(72) Inventor: Robert Kegley, Malibu, CA (US)

(21) Appl. No.: 15/296,044

(22) Filed: Oct. 18, 2016

(51) Int. Cl. F16M 13/02; E06B 9/00

(52) U.S. Cl. CPC F16M 13/02; E06B 2009/002; E06B 9/00

(57) ABSTRACT

A reusable safety fitting having an elongate member with first and second opposing ends, a fastener portion disposed at the first end of the elongate member, a handle portion disposed at the second end of the elongate member and a stop disposed between the first and second ends, as well as a method for using the reusable safety fitting to barricade an opening.

### BACKGROUND

### 1. Field

The present invention relates to articles of manufacture and methods of using the same. More particularly, the present invention relates to fittings and methods of using the fittings to block an opening.

### 2. Background

During the construction of buildings, it is necessary to place a barricade across openings such as door frames, window frames and the like to prevent a worker, visitor or occupant from falling through the opening. Often such barricades are simply boards, such as 2×4's, nailed across an opening. It is a disadvantage of such barricades that they are not readily used. For example, even if removed from an opening with the nails in condition for reuse, it is dangerous to have boards with exposed nails around work sites. Consequently, it is a desideratum for simple, effective and inexpensive safety fittings that can be used to barricade opens. It is a further desideratum for such fittings that are reusable.

### BRIEF DESCRIPTION OF THE INVENTION

Now there has been found a fitting that solves these needs and provides related advantages. In one aspect of the invention, a reusable safety fitting comprises an elongate member having first and second opposing ends, a fastener portion disposed at the first end of the elongate member, a handle portion disposed at the second end of the elongate member; and a stop disposed between the first and second ends. In one aspect, the fastener portion is nail, screw or bolt portion and in one aspect, the fastener proportion is a screw portion.

In one aspect, the handle portion is comprised of at least two handle elements extending radially from the second end of the elongate member. In another aspect the handle portion is comprised of two handle elements. In still another aspect, the two handle elements are integral and, in still another aspect, the two handle elements have a common longitudinal axis.

In one aspect, the stop is fixedly secured to the elongate member and, in one aspect, the stop is adjustably secured to the elongate member.

In another aspect, there has been found, a method for blocking an opening having first and second opposing sides and a bottom, comprising removably securing a first reusable safety fitting comprising a first elongate member having first and second opposing ends, a first fastener portion disposed at the first end of the first elongate member, a first handle portion disposed at the second end of the first elongate member, and a first stop disposed between the first and second ends of the first elongate member, whereby the first replaceable safety fitting abuts the first opposing side and a first receptacle is formed between the first reusable safety fitting and the first opposing side and removably securing a second reusable safety fitting comprising a second elongate member having first and second opposing ends, a second fastener portion disposed at the first end of the second elongate member, a second handle portion disposed at the second end of the second elongate member, and a second stop disposed between the first and second ends of the second elongate member, whereby the second reusable safety fitting abuts the second opposing side and a second receptacle is formed between the second reusable safety fitting and the second opposing side. A first end of at least one barricade having first and second opposing ends is placed in the first receptacle and the second end is placed in the second receptacle to block the opening.

In one aspect, the first and second fastener portions are nail portions, screw portions and, in one aspect, the fastener portions are screw portions. And in one aspect, the first and second handle portions are each comprised of at least two handle elements extending radially from the second end of the elongate member. In one aspect, the first and second handle portions are each comprised of two handle elements and, in one aspect, the two handle elements are integral and wherein each of the two handle elements has a common longitudinal axis.

In one aspect, the stop is fixedly secured to the elongate member. In one aspect, the barricade is a board or a rod and, in one aspect, the barricade is a board. In another aspect, the first and second reusable safety fittings are attached to the opposing sides of the opening equidistant from the bottom of the opening.

### BRIEF DESCRIPTION OF THE DRAWINGS

The accompanying drawings, together with the specification, illustrate exemplary embodiments, and, together with the description, serve to explain the principles of these embodiments.

FIG. 1 is a perspective view illustrating an aspect of a reusable safety fitting in accordance with a first aspect of the invention.

FIG. 2 is an exploded perspective view of a reusable safety fitting in accordance with a second aspect of the invention.

FIG. 3 is a perspective view of a doorway blocked with a piece of lumber using a first and second safety fittings in accordance with the invention.

FIG. 4 is a cut-away view taken along lines 4-4 of FIG. 3.

### DETAILED DESCRIPTION OF THE PREFERRED EMBODIMENTS

Particular embodiments of the invention are described below in detail for the purpose of illustrating its principles and operation. However, various modifications may be made and the scope of the invention is not limited to the exemplary embodiments described below.

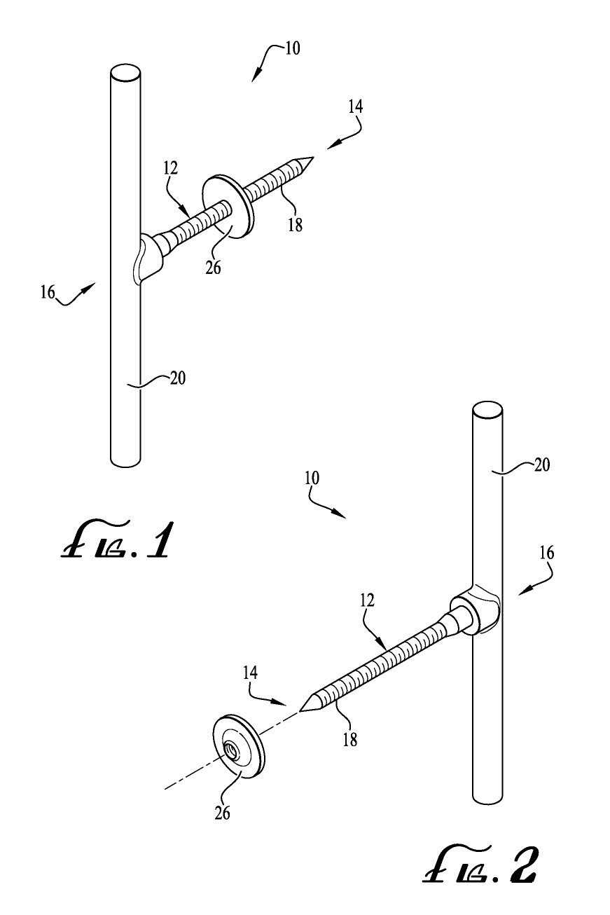

Shown in FIG. 1 is a perspective view illustrating one aspect of a reusable safety fitting in accordance with a first aspect of the invention. The reusable safety fitting 10 is comprised of an elongate member 12 having a first opposing end 14 and a second opposing end 16. A fastener portion 18 is disposed at the first end of the elongate member and a handle portion 20 is disposed at the second end of the elongate member. A stop 26 is disposed between the first and second end. The reusable safety fitting can be made out of any suitable material including, without limitation metal, engineered plastics, carbon fiber materials and the like. In some embodiments, the metal is steel, tin or brass, with steel being preferred.

In one aspect, the elongate member is a rod. In one embodiment, the rod has a length of from about 2 inches to about 6 inches and in one embodiment, the rod has a length of from about 3 inches to about five inches.

In another aspect of the invention, the fastener portion 18 includes, but is not limited to, a nail portion, a screw portion, a bolt portion (self-tapping or otherwise) or the like. In the representative embodiment shown in FIG. 1, the fastener portion is a screw portion.

In one aspect, the stop 26 comprises a flange extending radially from the elongate member. In one embodiment, the flange extends from about ¼ inch to about 1 inch from the elongate member and, in one embodiment, the flange extends about ½ inch from the elongate member. The stop can have any suitable cross-section, including without limitation, a circular cross section. In the representative embodiment shown in FIG. 1, the stop completely encircles the elongate member.

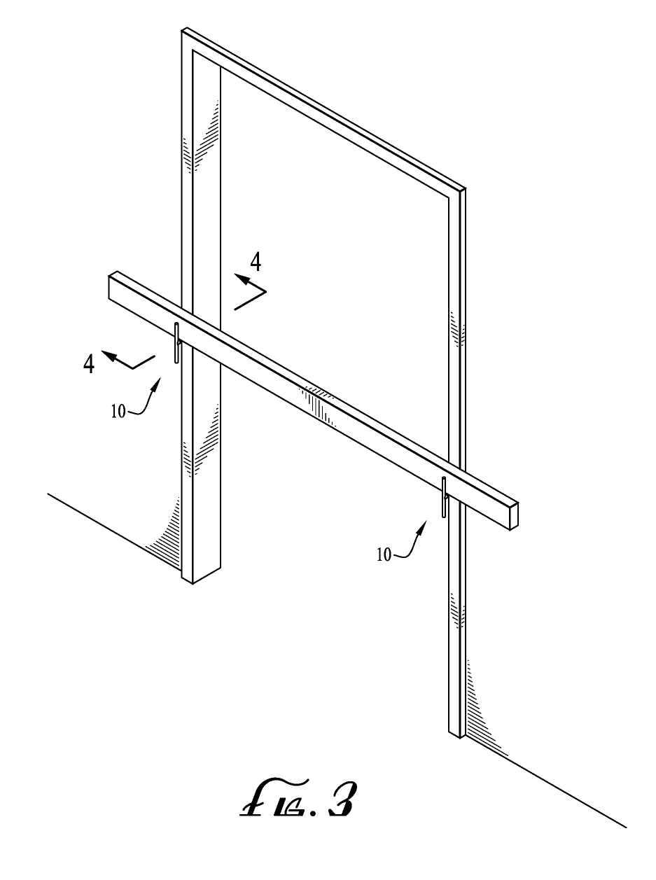

In one aspect, the stop 26 is fixedly secured to the elongate member 18 and, in one aspect, the stop is adjustably secured to the elongate member. As best seen in FIG. 2, an exploded perspective view of a reusable safety fitting in accordance with a second aspect of the invention, at least a portion of the elongate member is externally threaded and an internally-threaded stop is adjustably threaded on the elongate member.

In yet another aspect, the handle portion 16 is comprised of at least two handle elements extending radially from the second end of the elongate member 18. The handle elements can be of any suitable length and can have any suitable cross section. In one aspect, the length of the handle elements is from about 4 inches to about 8 inches and, in one aspect, the length of the rod is about 6 inches. In another aspect, the handle portion is comprised of two handle elements. As illustrated in the representative embodiments shown in FIGS. 1 and 2, in some embodiments, the two handle elements are integrally formed and, in some embodiments, the two handle elements have a common longitudinal axis. In the representative embodiments shown in FIGS. 1 and 2, the handle is formed of a circular rod. In some embodiments, the rod has a diameter of from about ¼ inch to about ¾ inches and, in some embodiments, the circular rod had a diameter of about ⅜ inch to about ¾ inch.

In another aspect of the invention, there has been discovered a method for blocking an opening having first and second opposing sides and a bottom. Representative openings include, without limitation door frames and window frames.

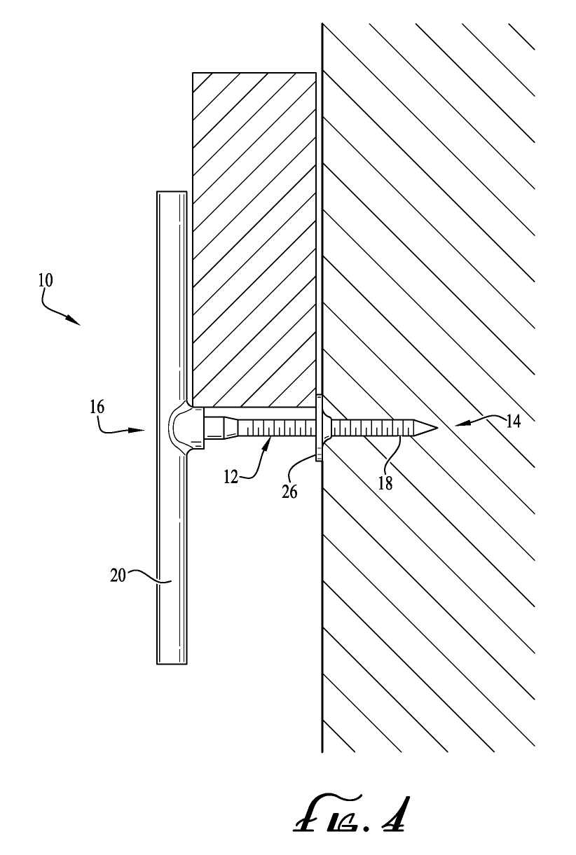

In one aspect of the method, each reusable safety fitting 10 comprises an elongate member 12 having a first opposing end 14 and a second opposing end 16. A fastener portion 18 is disposed at the first end of each elongate member and a handle portion 20 is disposed at the second end of each elongate member. A stop 26 is disposed between the first and second ends of each elongate member. As shown in FIG. 3, a perspective view of a doorway blocked with a piece of lumber using a pair of safety fittings in accordance with the invention, and FIG. 4, a cut-away view taken along lines 4-4 of FIG. 3, the method includes the steps removably securing a pair to safety fittings to the opposing sides of the opening.

As best seen in FIG. 4, the reusable safety fittings are secured so that each stop abuts an opposing side and a receptacle is formed between each reusable safety fitting and each opposing side of the opening. In an alternative embodiment, the rsfs do not include stops. In such embodiments, the rsf is secured to the side of the opening such that that a predetermined distance between the opening and the handle is created. The predetermined distance can be measured, for example with a tape measure. In an alternative embodiment an indicia of the predetermined distance, such as by forming a colored marking on the elongate member to signify the predetermined distance between the opening and the handle

Then, as shown in FIG. 3, the first end of at least one barricade having first and second opposing ends is placed in a first receptacle and the second end of the at least one barricade is placed in the second receptacle to block the opening. In one aspect, the first and second reusable safety fittings are attached to the opposing sides of the opposing openings equidistant from the bottom of the opening.

It is a distinct benefit of the invention that the reusable safety fitting 10 can be adapted to accommodate any suitable barricade. For example, in the representative embodiment shown in FIGS. 3 and 4, the portion of the elongate member 12 between the first end 14 and the stop 26 is flat to accommodate flat barricades, including without limitation, boards and flat metal rods. In alternate embodiments, the portion of the elongate member between the first end and the stop is curved to accommodate curved surfaces, such as the surfaces of curved metal rods.

It is another benefit of the invention, that the size of the receptacle can be dimensioned so that the receptacle can receive one or more barricades. For example, in those embodiments, where the barricade is a single 2×4 board, the distance between the stop and the handle is about 1 9/16 inch and the distance from the stop to the first end is at least 1¼ inch. In alternative embodiments, the receptacle is dimension to receive two horizontally aligned 2×4 boards. In such embodiments, the distance between the stop and the handle is about 3¼ inch and the distance from the stop to the first end is at least 1½ inch.

It is still another distinct advantage of the invention that when the barricade is no longer needed the barricade and the reusable safety fitting are simply removed by reversing the steps. In one aspect, the first and second ends of the barricade are removed from the first and second receptacles and then the first and second reusable safety fittings are removed from the opposing sides of the opening. The reusable safety fittings are then available for reuse when the need arises.

From the above description of the invention, those skilled in the art will perceive improvements, changes and modifications. For example, one skilled in the art will appreciate that other agents and materials, such as charged organic polymers (e.g., polyethyleneimine) and/or organosilica nanoparticles having different surface chemistries can be included in the sensor material to facilitate detection of sorbates. Such improvements, changes, and modifications are within the skill of the art and are intended to be covered by the appended claims.

I claim:

1. A reusable safety fitting comprising:
an elongate member having first and second opposing ends;
a fastener portion disposed at the first end of the elongate member;
a handle portion disposed at the second end of the elongate member; and
a stop disposed between the first and second ends.

2. The reusable safety fitting of claim 1 wherein the fastener portion is a nail portion, a screw portion or a bolt portion.

3. The reusable safety fitting of claim 1 wherein the fastener proportion is a screw portion.

4. The reusable safety fitting of claim 1 wherein the handle portion is comprised of at least two handle elements extending radially from the second end of the elongate member.

5. The reusable safety fitting of claim 1 wherein the handle portion is comprised of two handle elements.

6. The reusable safety fitting of claim 4 wherein the two handle elements are integral.

7. The reusable safety fitting of claim 5 wherein the two handle elements have a common longitudinal axis.

8. The reusable safety fitting of claim 1 wherein the stop is fixedly secured to the elongate member.

9. The reusable safety fitting of claim wherein the stop is adjustably secured to the elongate member.

10. A method for blocking an opening having first and second opposing sides and a bottom, comprising:
removably securing a first reusable safety fitting comprising:
a first elongate member having first and second opposing ends;
a first fastener portion disposed at the first end of the first elongate member;
a first handle portion disposed at the second end of the first elongate member; and
a first stop disposed between the first and second ends of the first elongate member, whereby the first replaceable safety fitting abuts the first opposing side and a first receptacle is formed between the first reusable safety fitting and the first opposing side;
removably securing a second reusable safety fitting comprising:
a second elongate member having first and second opposing ends;
a second fastener portion disposed at the first end of the second elongate member;
a second handle portion disposed at the second end of the second elongate member; and
a second stop disposed between the first and second ends of the second elongate member, whereby the second reusable safety fitting abuts the second opposing side and a second receptacle is formed between the second reusable safety fitting and the second opposing side; and
placing a first end of at least one barricade having first and second opposing ends in the first receptacle and the second end in the second receptacle to block the opening.

11. The method of claim 10 wherein the first and second fastener portions are nail portions, screw portion or bolt portions.

12. The method of claim of claim 11 wherein first and second fastener portions are nail portions.

13. The method of claim of claim 10 wherein the first and second handle portions are each comprised of at least two handle elements extending radially from the second end of the elongate member.

14. The method of claim of claim 10 wherein the first and second handle portions are each comprised of two handle elements.

15. The method of claim of claim 14 wherein the each of the two handle elements is integral and where each of the two handle elements has a common longitudinal axis.

16. The method of claim 10 wherein the first and second stops are each fixedly secured to the elongate member.

17. The method of claim 10 where the barricade is a board or a rod.

18. The method of claim 17 where the barricade is a board.

19. The method of claim 10 where the first and second reusable safety fittings are attached to the opposing sides of the opening equidistant from the bottom of the opening.

20. The method of claim wherein the fitting is a door frame.
